(19) United States
(12) Patent Application Publication
(10) Pub. No.: US 2012/0078736 A1
(43) Pub. Date: Mar. 29, 2012

(54) ON-DEMAND GENERATION OF TENDER IDS FOR PROCESSING THIRD-PARTY PAYMENTS VIA MERCHANT POS SYSTEMS

(75) Inventors: Karl Denzer, Denver, CO (US); William D. Young, Denver, CO (US)

(73) Assignee: PAYCODE SYSTEMS, INC., Denver, CO (US)

(21) Appl. No.: 13/228,299

(22) Filed: Sep. 8, 2011

Related U.S. Application Data
(60) Provisional application No. 61/380,960, filed on Sep. 8, 2010.

(51) Int. Cl. G06Q 20/40

(52) U.S. Cl. 705/16

(57) ABSTRACT

A closed loop payment system, such as those leveraged to activate or process gift cards, is employed to enable consumers to make payments for multiple payees at a plurality of retail locations. The systems, methods and techniques also enable financial settlement of the consumer payments across multiple parties, and the systems, methods and techniques enable consumers to manage an individual payment profile using an Internet connected device or mobile phone.

### CROSS-REFERENCE TO RELATED APPLICATIONS

The present application claims the benefit of U.S. Provisional Patent Application No. 61/380,960, filed Sep. 8, 2010, the entire disclosure of which is hereby incorporated herein by reference.

### TECHNICAL FIELD

An exemplary embodiment of this disclosure relates to closed loop payment systems, such as those leveraged to activate or process gift cards, which are employed to enable consumers to make payments for multiple payees at a plurality of retail locations. Another exemplary embodiment of this disclosure relates to systems, methods and techniques that enable financial settlement of the consumer payments across multiple parties, and systems, methods and techniques that enable consumers to manage an individual payment profile using an Internet connected device or mobile phone.

### BACKGROUND OF THE DISCLOSURE

Currently, many companies who regularly accept direct consumer payments operate expensive payment centers (e.g., cable companies, wireless providers, utilities, etc.). These are often physical locations designed to enable walk-in consumers to make a payment by cash, credit or check. This provides an alternative to customers who need, for whatever reason, to pay in cash vs. credit or check. Those companies that do not have walk-in payment centers also must provide options to consumers and, as such, they work with vendors such as Western Union® to accept direct consumer payments. These collection entities charge a fee to the consumer and often a separate fee to settle with the payee, and either requires the consumer to bring their bill into the retail location, or to have a card specific to an individual payee to manage payments.

This traditional model results in several challenges:
(1) High-cost of operating physical, walk-in payment locations;
(2) High cost of processing payments with collection vendors such as Western Union®;
(3) Poor customer experience as walk-in payment locations often have lengthy lines at the end of a month, and collection vendors often require complex processes to accept payments;
(4) Poor customer choice as walk-in locations and collection vendors are limited and must be sought out by the consumer.
(5) High cost of supporting specific payees at a retail location due to the need to issue payee and/or merchant specific cards and/or have customer service personnel enter information into a computer in order to process a payment

### SUMMARY

An exemplary embodiment of the present disclosure overcomes these challenges by enabling payments to third parties to be made at a plurality of branded retail locations (including without limitation national retail chains such as Walmart®, Target®, Kroger®, Walgreens®, Dollar General®, and the like). An exemplary embodiment described herein enables payment information to be created dynamically, ‘staged’ by the consumer; recognized and accepted by the Merchant; recognized and tracked by the Payee; and settled among the parties.

On exemplary advantage of the present disclosure has the added benefit of being managed via a mobile or Internet connected device. Many believe that supporting payments from mobile devices, such as a mobile phone, will enable more efficient and cost-effective payments. The introduction of mobile technologies, in part, enables the present disclosure to deliver material value to the parties involved. This benefit will only increase with greater penetration of consumer devices such as Near-Field Communication (NFC)-enabled mobile phones and merchant hardware such as contactless readers at merchants' POS systems.

Embodiments of the present disclosure overcome the above challenges as they: (1) enable service providers to leverage a broadly distributed network of retail locations to accept payments; (2) provide consumers with additional locations where such payments can made; and (3) enable such payments to be made in cash vs. check or credit card. Embodiments of the present disclosure are directed to a method, computer program and system for managing transactions for a plurality of third-party entities via a central processing system, which receives a transaction request from a consumer and generates on-demand Tender ID(s) that, when entered into an authorized merchant's point-of-sale (POS) system, invokes a message from the POS system to the central processing system to trigger the consumer-requested transaction with the third party, which could include, but is not limited to, bill payment, money transfer, or account deposits, and the subsequent settlement of funds between the third-party and the central processing system using methods including, but not limited to, ACH transfer, transfer via the credit network, or mailing a check.

Tender ID(s) are dynamically generated and tailored to each merchant's POS system such that transactions may be processed at a plurality of locations through means including optical scanning of barcodes generated to specifications of the merchant's POS system, manual entry of data into the merchant's POS, Near Field Communication (NFC) of the Tender ID and other means as deemed necessary. Tender IDs generated by the central processing system may reference a single transaction or may be reused multiple times for related transactions (e.g., transactions involving a common merchant and transaction type), and they are linked via a database to the consumer that initiated the transaction, the requested transaction type, and the retailer through whom the funds are to be remitted.

Tender IDs are also tied within the Central Processing System to separate, unique Transaction ID(s) which can be linked to the specific third-party(ies) to whom funds are to be remitted, the amounts to be remitted, specific accounts to which funds are to be directed, and other information as deemed necessary; and such Transaction IDs are then referenced in the settlement of funds with third party entities, which may include service or product providers, individuals, consumer accounts or other entities with which the consumer may wish to transact. Transactions may involve the payment of bills, remittance of funds to an individual or individual's account, insertion of funds to a consumer account, or any other financial transaction that requires the collection and disbursement of funds. Transactions linked to a Tender ID may involve the transfer of funds from a user, such as cash or credit provided by a consumer, or drawn from a user account (e.g., savings, checking, prepaid account balance), to a separate account, which is either owned by that user or a third-party, via a merchant's POS system.

Requests for a unique Tender ID may be generated by a mobile communications device, an internet-connected PC, an interactive voice response system, or any other method through which the consumer and the requested transaction may be received and identified by the central processing system. Payment by the consumer at the retail POS system may be made via cash, credit, debit or any other tender accepted by the specific merchant.

These and other advantages will be apparent from the disclosure of the disclosure(s) contained herein. The above-described embodiments and configurations are neither complete nor exhaustive. As will be appreciated, other embodiments of the disclosure are possible utilizing, alone or in combination, one or more of the features set forth above or described in detail below.

### BRIEF DESCRIPTION OF THE DRAWINGS

FIG. 1 is a flowchart illustrating an embodiment of a system and method through which the consumer is able to establish a profile within the Central Processing System, and upon subsequent use is authenticated to initiate an interaction session with the System, and his or her profile is retrieved for use during that session;

FIG. 2 is a flowchart illustrating several embodiments of a system and method to produce unique Tender IDs on demand, and deliver those IDs to a mobile device or Internet connected computer such that they may be recognized by a plurality of merchant Point of Sale (POS) systems to enable transmission of funds from a consumer to a Merchant, and subsequently from the Merchant to a Payee;

FIG. 3 is a flowchart illustrating several embodiments of the use of a Tender ID to support a payment at a merchant POS system and the creation of a Transaction ID to govern the settlement with the intended Payee;

FIG. 4 is a flowchart illustrating several embodiments of financial settlement among the involved parties to ensure funds flow among all accounts as intended; and

FIG. 5 is a flowchart illustrating several embodiments of a process wherein consumers identify preferences and rules, which they would like to govern payments made at merchant locations and directed to Payees.

### DETAILED DESCRIPTION OF THE DRAWINGS

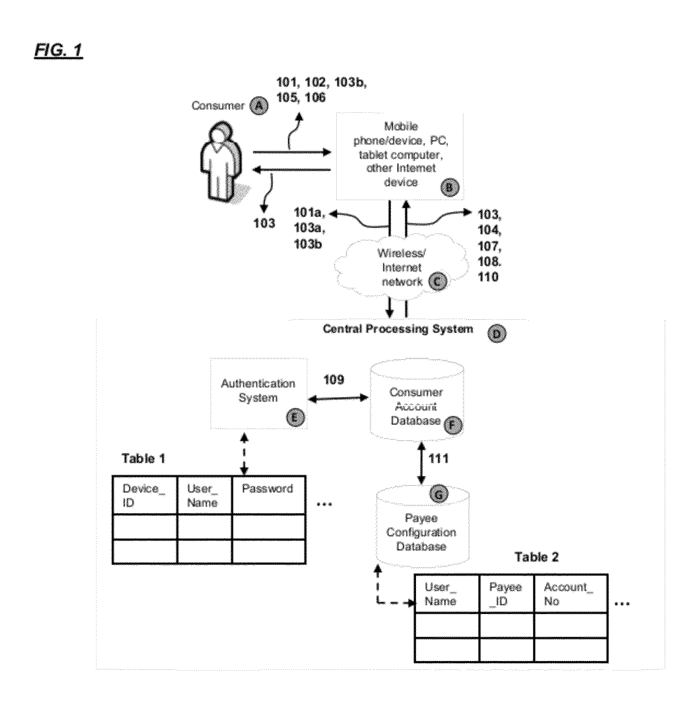

An embodiment of using a mobile device, Internet connected personal computer or other device to create and access a consumer's account for the purpose of making payments for 3^{rd} party services, including but not limited to cable services, mortgage payments, electric bills and other such services, at merchant locations, including but not limited to CVS®, Best Buy®, Walmart® and other like merchants, is illustrated in FIG. 1. At step 101, the method considers interaction between the consumer (element A) and the mobile device or other Internet connected device (element B) to establish the consumer's profile within the Central Processing System. At step 102, the consumer connects with the Central Processing System, and information regarding the connected device (element B) is sent to the authentication system (element E), such information can include, but is not limited to, device IP address, mobile phone number, SIM or IMEI, or other such data element which uniquely identifies the connected device. At step 103, the authentication system performs a validation on the unique ID provided by the connected device to determine if any profile exists for this device, a profile defined as parameters defined by the consumer, including, but not limited to, a unique password, password reminders, account information for Payees, and other information as defined in FIG. 1.

If the Authentication System determines that the unique ID provided by the consumer's connected device does not have an existing profile, which is determined by accessing the Authentication System database as illustrated in table 1, in step 104 the system will return a series of prompts to the Internet connected device (element B) to determine if the consumer has previously established an account using another device. If the consumer indicates in step 105 they have established an account, the Authentication System will require the consumer to enter personally identifiable information (PII) including, but not limited to, mobile phone number, account name, and account password. This information is collected by the Authentication System (element E) in step 107, and if this information matches data previously entered into the Authentication System (element E) as shown in table 2, then consumer is able to proceed with transaction(s) supported by the Central Processing System (element D).

If the Authentication System (element E) does not find an existing database record for the consumer within the Consumer Account Database (element F) at step 109, indicating that the customer does not have Payee profiles established, then at step 110 the consumer will be prompted to establish an account by providing information including, but not limited to, mobile phone number, primary e-mail account address, and selected password. After the account access data is established, the state of the customer's account is updated within the Consumer Account Database (element F), and the consumer would be promoted to enter Payee information, which would be stored within the Payment Configuration Database (element G, table 2).

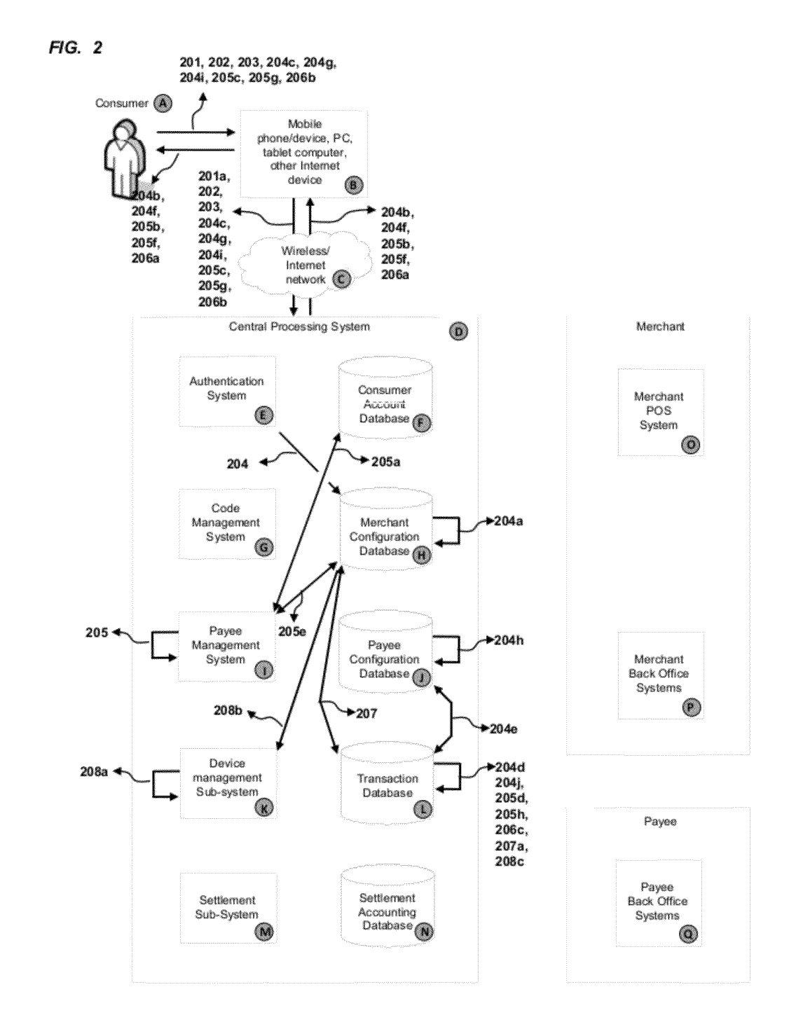

Once a consumer is authorized via the process detailed in FIG. 1, he/she may begin the process of making a payment to a Payee at a Merchant location. This process involves three steps: (1) The generation of a unique Tender ID, which will be recognized by the specific Merchant where payment is made; (2) the submission of that Tender ID to the merchant, and the corresponding generation of a Payee-recognized Transaction ID upon completion of the tender at the Merchant's Point of Sale (POS); and (3) the settlement of the funds among the Merchant, the Payee and the entity operating the Central Processing System described herein. Various methods for completing these three processes are detailed in FIGS. 2, 3 and 4.

As can be seen in FIG. 2 and subsequent figures discussed herein, certain system elements depicted and described in connection with multiple figures have been provided assigned common element numbers. One skilled in the art will appreciate, however, that this identification scheme is used for clarity and ease of understanding the various embodiments provided herein. This numbering scheme is not intended, nor should it be construed as limiting the scope of the disclosure. Particularly, similarly designated elements may actually vary from system to system depending upon the system's implementation. Furthermore, one skilled in the art will appreciate that the functions of multiple elements may be combined into a common element or various other configurations not discussed herein. Likewise, functions of a single element described herein may be executed by multiple different elements without departing from the spirit of the present disclosure.

An embodiment of using a mobile device, Internet connected personal computer or other device to generate a real-time, on-demand Tender ID and use Tender ID to transfer funds from the merchant to a payee through a Central Processing System is illustrated FIG. 2. At step 201, the method considers the interaction between the consumer (element A) and the mobile device, such as a phone or other personal device with Internet connectivity (element B), to manage an individual transaction. This interaction may involve an application that resides on the mobile device (element B), or may depend entirely on an application that is hosted remotely in the Central Processing System (element D), which is accessed through a connection over the wireless network (element C), as indicated in step 201a. Specific interaction—such as use of a touch-screen, trackball, keypad, voice commands, etc.—with the application will be governed by the mobile device used and the software resident on that device. At step 202, the customer (element A) indicates that that he/she would like to make a payment, and this indication is sent to the Central Processing System (element D) via the wireless network (element C). This indication triggers the authentication method detailed in FIG. 1. Once this authentication process is completed, the customer (element A) is prompted to enter information via the method and process detailed herein in order to obtain a Tender ID. The Tender ID is specific to each Merchant and, based on the specific requirements of that Merchant, represents without limitation some or all of the following: The Payee, the Product Code (e.g., a UPC or other consistent code linked to the type of transaction, such as a utility payment vs. a mortgage payment vs. an account deposit), the amount, and other items that may be required by the Merchant. The process to create and obtain a Tender ID has three steps: (1) selection of a Merchant and Payee; (2) selection of a payment amount, which may not be required for all Merchants; and (3) retrieval of a Product Code. These three steps, and various embodiments of each, are described below.

Step 203 represents the first step toward selecting a Merchant and Payee. In this step, the Consumer (element A) indicates whether he/she would like to first select a Payee then a Merchant, or select a Merchant first, then a Payee. This select represents two embodiments of this method as indicated below.

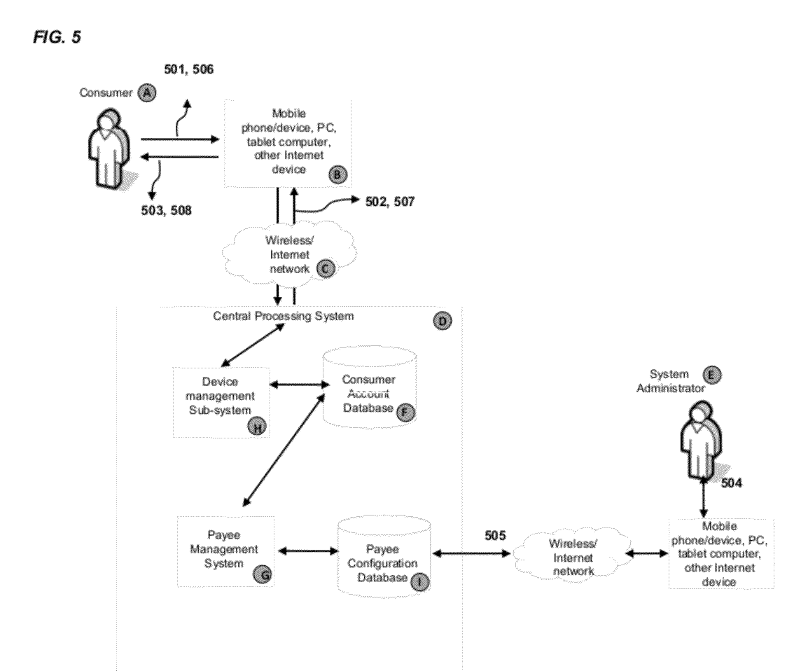

The first embodiment of the process to select a Merchant and Payee involves selection of the Merchant first, then selection of a Payee to whom a payment will be made. This embodiment begins at step 204, which begins after the Consumer (element A) has opted to select a Merchant, and is invoked by a successful authentication. Step 204a shows one method for prioritizing and providing a Merchant list based on the consumer's physical location at the time the initial payment request is made in step 201. This is possible provided the mobile device (element B) is able to detect physical location leveraging GPS or some other technology. In this method, the mobile device (element B) communicates the physical location of the consumer (element A) to the Authentication System (element E), which cross-references this location with the information contained in the Merchant Configuration Database (element H), such information to include ZIP code, location coordinates, or other information provided by the Merchants to pinpoint the location of individual stores. The result is a single Merchant, or small list of potential Merchants, which are linked to the consumer's (element A) likely location. Another option for prioritizing a list of Merchants involves recent payment activity as contained in the Transaction Database (element L) and/or time based rules that were defined by the consumer during the account set-up process depicted in FIG. 5 (e.g., the consumer may have previously indicated preferred merchants, or has demonstrated a pattern of paying at certain Merchants). The Merchant list is returned to the Consumer (element A) at step 204b. At step 204c, the consumer (element A) confirms or selects the Merchant in which they want to tender a payment, and a record with the Transaction Database (element L) is established and updated as indicated in step 204d.

The embodiment continues at step 204e, where the Central Processing System (element D) generates a list of 3^{rd} party Payees to the mobile device (element B). This list represents only Payees that accept payments at the Merchant selected in step 204c, and which have been previously set-up by the consumer (element A) as indicated in FIG. 5. As represented in step 204e, one method of displaying this list is to generate a default list of Payees via an interaction between the Payee Configuration Database (element J) and the Transaction Database (element L). One prioritization of this list may select Payees based on the consumer's (element A) recent payments and his/her transaction activity as contained in the Transaction Database (element L) (e.g., the 6 Payees for which the customer has made recent payments would be listed in order of most recent activity). Other prioritization options may be based on the customer set-up as described in FIG. 5. At step 204f the list is returned to the Consumer (element A). Note, another method, indicated in step 204g, allows the consumer to request a full list of all available Payees, which can be sorted in a default manner or based on consumer defined criteria (e.g., alphabetical, by category of Payee, etc.) and is retrieved from within the Payee Configuration Database (element J) as shown in step 204h. At step 204i, the consumer selects the 3^{rd} party Payee to whom they intend to transfer funds, and the record within the Transaction Database (element L) is updated in step 204j.

The second embodiment of the process to select a Merchant and Payee involves selection of the Payee first, then selection of a Merchant at which to submit a payment to that Payee. This embodiment is triggered during step 203 above, wherein the consumer indicates a preference to select a specific Payee, rather than view Payee options at a specific Merchant. This results in step 205, wherein the Payee Management System (element I) determines which Payees are accepting payments, and cross-references that in step 205a with the Customer Account Database (element F) to identify available Payees that have been set-up by the customer during the setup process detailed in FIG. 5. The result is a customized list of Payees returned to the consumer via the mobile device (element B) in step 205b. In step 205c the customer selects a specific Payee, and a record in the Transaction Management Database (element L) is created and updated in step 205d. Next, step 205e takes place, in which a list of Merchants that accept payments for that specific Payee is retrieved. This is done via interaction between the Payee Management System (element I) and the Merchant Configuration Database (element H), and may involve (1) a full default list of Merchants; (2) the retrieval of a specific Merchant, or small list of Merchants, based on the customer's (element A) physical location, as described in step 203 above; (3) the retrieval of a list of Merchants based on input during the setup process in FIG. 5; or (4) some other process to select from and prioritize within the full list of Merchants. This list is returned to the consumer in step 205f for the consumer to select, and such selection is returned to the Central Processing System in step 205g. At step 205h the record within the Transaction Management Database (element L) is updated to reflect the selected Merchant.

Once the Merchant and Payee have been determined using either embodiment described above, step 206 is invoked to determine whether the consumer (element A) must input a payment amount prior to the payment transaction at the Merchant. This is done via interaction between the Code Management System (element G) and the Merchant Configuration Database (element H). If a payment amount is required, a request to input the amount is sent to the consumer (element A) in step 206a. The consumer (element A) then enters this amount and returns it to the Central Processing System (element D) in step 206b. In step 206c, the amount is uploaded to the record within the Transaction Management Database (element L) created either at step 204b or step 205d.

Once a payment amount has been collected (if required), the Central Processing System (element D) retrieves a Product Code, which has been provided by the Merchant and may be linked to key variables such as transactions for a specific Payee and/or payment amount. This Product Code may be a UPC (Universal Product Code), a Merchant defined SKU (Shelf Keeping Unit) or other consistent code indicated by the Merchant and linked to select transaction variables (such as a utility payment vs. a mortgage payment vs. an account deposit, or a payment of greater or less than $50). As indicated in step 207, The Product Code is retrieved from the Merchant Configuration Database (element H) by cross referencing data stored in the Transaction Database (element L), which now contains a record of the Merchant, Payee and amount (if applicable). Once retrieved, the record within the Transaction Management Database (element L) created either at step 204b or step 205d is updated with the Product Code in step 207a.

In step 208, a unique Tender ID is generated via interaction between the Code Management System (element G) and the Transaction Database (element L), which now contains all information pertaining to a given transaction. The Tender ID is unique and created to be recognized by the specific Merchant at which the transaction is taking place. For example, a utility payment at merchant X may represent a 19-digit ID containing 4 data elements; whereas a transfer to a consumer account at merchant Y may represent a 16-digit ID containing 5 data elements. It will directly represent, or trigger the Merchant to recognize, key variables for the transaction including without limitation the Payee, the Product Code, the amount and any other variables that support the processing of a tender transaction in which the consumer (element A) makes a payment intended for a specific Payee. In step 208a, the Device Management System (element K) formats the Tender ID for display on the specific mobile device (element B), and to be recognized by the Merchant's POS system as indicated within the Merchant Configuration Database (element H) and retrieved via step 208b. Once generated, the Tender ID is associated to the transaction record in the Transaction Database (element L) in step 208c.

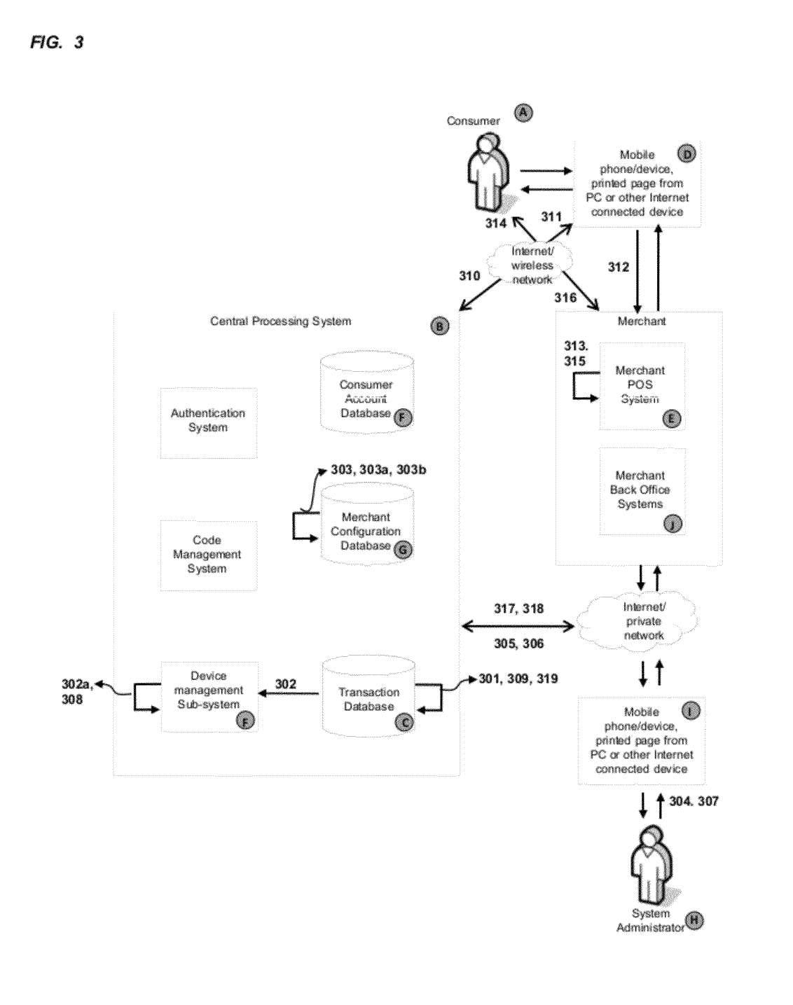

An embodiment of using a mobile device, Internet connected personal computer or other device to tender a payment for a 3^{rd} party Payee at a participating merchant location, and generate a unique transaction ID through the Central Processing System after the payment is tendered in a merchant's point of sale (POS) is illustrated in FIG. 3. At step 301, the Central Processing System (element B) retrieves the unique Tender ID from the Transaction Database (element C) that was established for the consumer's payment transaction as described in FIG. 2, and formats the Tender ID for display/rendering on the consumer's mobile device, Internet connected computer or other device (element D), such that the Tender ID can be recognized by the selected Merchant's POS system (element E). In step 302, the Central Processing System (element B) queries the Device Management Subsystem (element F) to obtain details on the consumer's device (element D) that would indicate how the Tender ID will be presented to the Merchant's POS (element E), by returning parameters that could include, but are not limited to, screen size, screen resolution, fixed vs. mobile device, NFC enabled, and other information as needed in order to render the transaction ID on a mobile device and/or printed page (element D). Once that information is determined, in step 303 the Central Processing System (element B) will query the Merchant Configuration database (element G) to determine what format the Merchant POS requires for the Tender ID. In step 303a, if the Central Processing System (element B) determines that the POS system for the selected merchant (element e) requires a barcode, then the system will query the Merchant Configuration Database (element G) in step 303b to determine whether the merchant POS requires separate barcodes for each data element (e.g., UPC and transaction ID as separate data elements) or a single barcode that could combine the UPC and transaction ID, and which barcode font should be rendered for the selected POS. Such formats could include, but are not limited to: QR code, code 128, code 6 of 9, code 39, and others. The information regarding the merchant requirements, formatting and other configuration data elements/parameters would be entered by a System Administrator (element H) into the Merchant Configuration Database (element G) via a PC, or other connected Internet device (element I) in steps 304 and 305, and once the merchant data is updated in the Merchant Configuration Database (element G), the System Administrator (element H) is notified via steps 306 and 307. If the Merchant Configuration Database (element G) indicates that the selected Merchant's POS can accept Near Field Communication (NFC) tender methods, and the Device Management Subsystem (element F) indicates that the consumer's mobile device (element E) supports NFC communications, then the Central Processing System (element B) will query the Device Management Subsystem (element F) to determine the NFC communication standard and data requirements for the specific consumer's device (element E) in step 308. Once these steps are completed, in step 309 the Transaction Database (element C) will be updated with the configuration data necessary to support the consumer's transaction at POS, and at step 310 this data will be communicated in real time to the consumer's mobile device or Internet connected PC, which will enable the device to render, in real time, a tender ID that can be recognized by the selected merchant's POS system (element E).

Once the tender ID is presented to the consumer's device in step 311, and rendered on the mobile screen, on a printed receipt, or stored within the NFC system within the phone, the consumer will present the tender ID to the merchant's POS in step 312. The merchant's POS will scan or read the tender ID in step 313, using a scan of the barcode, an NFC read of the tender ID, or other method, which could include but is not limited to the POS clerk manually entered the tender ID into the POS, which will trigger the POS to prompt the consumer for a payment in step 314, in a manner determined within the coding and logic of the POS system. The prompt may be for a open denomination payment (e.g., lower bound of $25 upper $250), or for a fixed amount, with the logic for determining the payment thresholds and amount being driven by the interaction of the UPC and/or merchant specific SKU portion of the Tender ID and code resident within the POS system as shown in step 315.

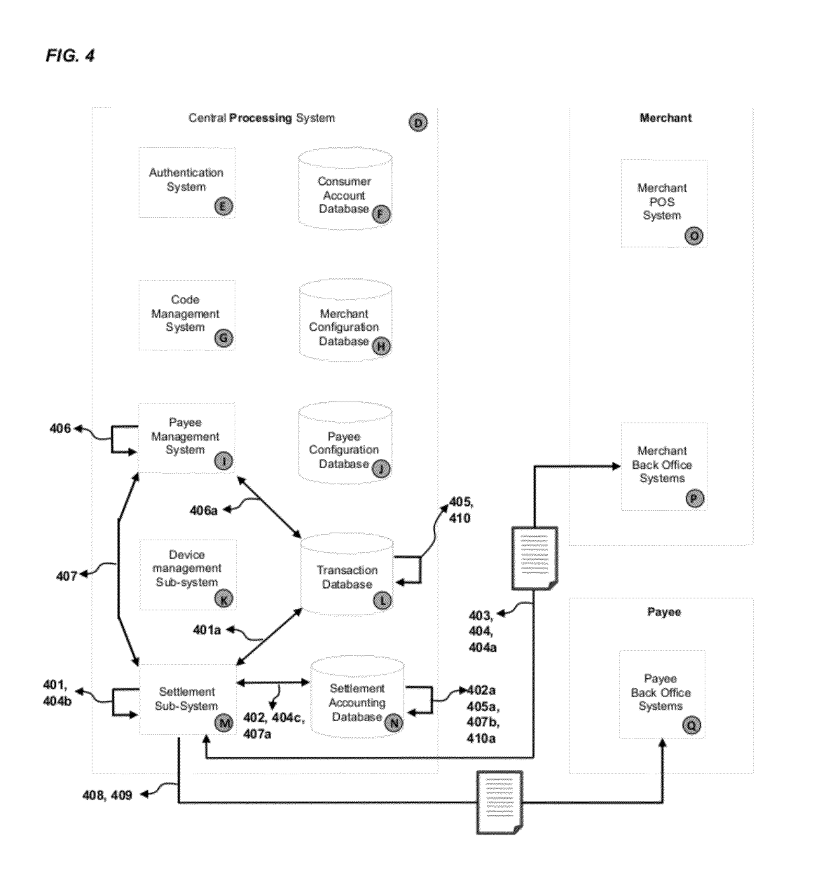

In step 316, the consumer has made a confirmed payment via the merchant POS using an authorized tender method, which could include, but is not limited to, cash, credit card, debit card, gift card, mobile wallet, or other means as determined by the merchant's POS code, and the merchant's POS code triggers the POS to route the transaction through the merchant's store/corporate network (element J) to the Central Processing System (element B) in step 317 based on the characteristics of the Tender ID, including, but not limited to, the UPC and/or merchant SKU, such routing to be performed either in real-time or via batch method, which could include, but are not limited to, FTP file transfers. In step 318, the merchant POS sends the transaction to the Central Processing System, and provides data including, but not limited to, the merchant identifier, date/timestamp, store number, register number, and Tender ID for the transaction. In step 319, the Central Processing System (element B) receives and validated the transaction, creates a unique transaction ID associated with the transaction, and stores the details of the transaction, including, but not limited to, the consumer's profile ID, merchant ID, Payee ID, payment amount, merchant location, date/time of transaction, in the transaction database. At step 319 this process is complete, and the transaction is ready for settlement as described in FIG. 4.

An embodiment of settling payment among the involved parties using the Tender and Transaction IDs is illustrated in FIG. 4. At step 401, the Settlement Sub-System (element M) identifies the business logic that governs settlement with the Merchant. For example, the system may indicate that settlement of customer payments to Merchants be handled every 24 hours, 48 hours, weekly, etc.; and the format of and line items that are required within settlement files that are exchanged with individual Merchants. This logic is cross-referenced with recent consumer transactions made at Merchants via an interaction between the Settlement Sub-System (element M) and the Transaction Database (element L) as indicated in step 401a. Two critical functions occur in this step: (1) pending financial settlements with each Merchant are compiled, and the Merchant-recognized unique Tender ID (as distinct from the Payee-recognized Transaction ID) is associated with each file (this is the same Tender ID established as part of the initial consumer payment detailed in FIG. 2); and (2) pending financial settlements with each Payee are compiled and the Payee-recognized unique Transaction ID is associated with each file (this is the same Transaction ID established as part of the initial consumer payment detailed in FIG. 2). Once data is compiled, settlement transactions are scheduled and posted to the Settlement Accounting Database (element N), which is updated to reflect such pending transactions as represented in step 402 and step 402a.

Step 403 occurs between the Central Processing System (element D) and the Merchant Back-office System (element P) once a scheduled settlement transaction occurs. In this step, the Settlement Sub-System (element M) compiles a data file, which includes the Tender ID (as opposed to the Transaction ID, which is linked to the Payee), amount of each transaction, and, without limitation, any other data fields which are required to process settlement such as store ID, date, time, etc. This file is then sent from the Settlement Sub-System (element M) to the Merchant Back-office System (element P). This submission, and all file transfers and submissions in this method, may be physical or electronic and may involve, without limitation, standard mail, an FTP post, transmission via a custom Application Protocol Interface (API) or any other method leveraged by the Central Processing System (element D) and the Merchant. In step 404 a payment file is submitted by the Merchant Back-office System (element P) to the Settlement Sub-System (element M), which contains payment status associated with each Tender ID submitted by the Settlement Sub-System (element M), and whatever additional information is required by the Merchant and the Central Processing System (element D) to settle the transactions. The submission of this file in step 404 is linked to the submission of actual payment from the Merchant to the entity operating the Central Processing System (element D). The specific method for this payment is independent from the transfer of settlement files and may include, without limitation, and ACH (automated clearing house) transaction, physical check, EFT (electronic funds transfer) or other appropriate method.

Another embodiment of transferring settlement files between the Back-office System (element P) and the Central Processing System (element D) is represented in step 404a, in which a settlement file is first transmitted by the Merchant Back-office System (element P) to the Settlement Sub-System (element M) without first receiving a file from the Settlement Sub-System (element P). This would be done to accommodate policies and procedures for the individual Merchant, and may or may not be linked directly to a corresponding payment. In this embodiment, the Settlement Sub-System (element P) will identify any discrepancies between the file received by the Merchant Back-office System (element P) and the records contained in the Settlement Accounting Database (element N) as represented in step 404b and step 404c, and manage those discrepancies in the manner that best conforms to the processes of the individual Merchant.

Results of the settlement process with the Merchant are then recorded within the Transaction Database (element L) and the Settlement Accounting Database (element N) as represented in step 405 and step 405a. It is important to note that individual settlements from Merchants are linked to Merchant-specific Tender IDs not only to Payees and, as such, may contain payments associated with multiple Payees.

The settlement process with Payees, which is independent from the settlement with Merchants, begins at step 406. In this step the Payee Management Sub-System (element I) identifies the business logic that governs settlement with each individual Payee. For example, the system may indicate that settlement of customer payments at Merchants to Payees be handled every 24 hours, 48 hours, weekly, etc.; and the format of and line items that are required within settlement files that are exchanged with individual Payees. This logic is cross-referenced with recent consumer transactions made at Merchants and linked to individual Payees via an interaction between the Payee Management Sub-System (element I) and the Transaction Database (element L) as indicated in step 406a. As with the similar process with Merchants, two critical functions occur in this step: (1) pending financial settlements with each Payee are compiled, and the Payee-recognized unique Transaction ID (as distinct from the Merchant-recognized Tender ID) is associated with each file (this is the same Transaction ID established as part of the initial consumer payment detailed in FIG. 2); and (2) pending financial settlements with each Payee are compiled and the Payee-recognized unique Transaction ID is associated with each file (this is the same Transaction ID established as part of the initial consumer payment detailed in FIG. 3). Once data is compiled, information on pending settlement transactions is delivered to the Settlement Sub-System (element M) in step 407, and the exchange of required settlement files and payments with the Payee are scheduled and posted to the Settlement Accounting Database (element N), which is updated to reflect such pending transactions as represented in step 407a and step 407b. Note, in one embodiment of this method, the use of a separate Payee Management System (element I) is not required, and all logic is kept within the Settlement Sub-System (element M). The use of two separate systems was reflected to accommodate a large and dynamic number of Payees supported by the Central Processing System (element D).

Step 408 occurs between the Central Processing System (element D) and the Payee Back-office System (element Q) once a scheduled settlement transaction occurs. In this step, the Settlement Sub-System (element M) compiles a data file, which includes the Transaction ID (as opposed to the Tender ID, which is linked to the Merchant), amount of each transaction, and, without limitation, any other data fields which are required to process settlement such as, date, time, etc. This file is then sent from the Settlement Sub-System (element M) to the Payee Back-office System (element Q). This submission, and all file transfers and submissions in this method, may be physical or electronic and may involve, without limitation, standard mail, an FTP post, transmission via a custom Application Protocol Interface (API) or any other method leveraged by the Central Processing System (element D) and the Payee. The submission of this file in step 409 is linked to the submission of actual payment from the entity operating the Central Processing System (element D) to the Payee. The specific method for this payment is independent from the transfer of settlement files and may include, without limitation, and ACH (automated clearing house) transaction, physical check, EFT (electronic funds transfer) or other appropriate method.

Results of the settlement process with the Payee are then recorded within the Transaction Database (element L) and the Settlement Accounting Database (element N) as represented in step 410 and step 410a. It is important to note that individual settlements from Payees are linked to Payee-specific Transactions IDs not only to Merchants and, as such, may contain payments associated with multiple Merchants.

The four prior diagrams describe the process for using Tender IDs and Transaction IDs to submit a payment to a third-party Payee from within a Merchant location. The final diagram, FIG. 5, describes the process for the consumer to configure and personalize the data used to process such payments and, as such, is a critical aspect of the disclosure considered herein.

An embodiment of using a mobile device, Internet connected personal computer or other device to set up rules and preferences that govern what 3^{rd} party payments customers can tender within participating merchants is illustrated in FIG. 5. This method considers the interaction between the customer's profile, as established in FIG. 1 and the Payee Management System (element D) whereby the consumer is able to select from a pre-defined list of Payees, including, but not limited to, cable companies, electric companies, satellite TV providers, wireless companies, mortgage service firms, gyms, and other types of companies that accept periodic payments from consumers in order to set up a customized list of Payees and the corresponding consumer's account information for each Payee. In step 501, the consumer (element A) requests a list of participating Payees from the Central Processing System (element D) via their mobile or Internet connected device (element C), and in step 502 the Central Processing System returns a list of eligible Payees which the consumer will be able to sort/filter in step 503 based on category (e.g., utility, TV), alphabetical list, or geographic location (based on information provided by the consumer during the authentication/account set-up process as described in FIG. 1). The list of eligible Payees having been previously set-up in the Central Processing System by a System Administrator (element E), using a PC or other Internet connected device (element F) to enter applicable information for each participating Payee into the Payee Configuration Database (element D) in step 504 and step 505, such information can include, but is not limited to, Payee name, address, phone number, account number rules, payment method type, and other information as deemed necessary.

At step 506 the consumer will select a Payee from the list, and will be prompted to provide information to identify their account with the Payee by providing information according to data/schema that is returned to the consumer's device (element C) by the Central Processing System for the selected Payee. Such data will vary according to the specific requirements of each Payee, and which are stored and retrieved from the Payee Configuration Database (element D).

After the consumer enters the information required to establish their account with the Payee, this information is passed back to the Central Processing System in step 507, and is validated based on the parameters defined within the Payee Configuration Database (element I), for example, the account number of Acme Bank should be 10 digits, beginning with a “0”. In addition to establishing an account with a Payee, a consumer can set up specific rules with each Payee, including establishing periodic reminders for payments that can be based on day of the month and/or consumer's proximity to a participating merchant (assuming that the consumer's mobile device can support location based data). These alerts would trigger “push” notifications to the consumer's mobile and/or Internet connected device (element B) when the rules are trigged, and would be delivered in a format for each device as defined by the Device Management Subsystem (element H) in step 508. Once the Payee set-up information is validated within the Payee Configuration database, then the Payee Management System (element G) updates the Customer Account Database (element F) with the Payee ID and any applicable notification rules, which will enable the consumer to make payments for the selected Payee using the Central Processing System.

While the above-described flowcharts have been discussed in relation to a particular sequence of events, it should be appreciated that changes to this sequence can occur without materially effecting the operation of the disclosure. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols of this disclosure can be implemented on a special purpose computer in addition to or in place of the described communication equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a server, personal computer, any comparable means, or the like. In general, any device capable of implementing a state machine that is in turn capable of implementing the methodology illustrated herein can be used to implement the various communication methods, protocols and techniques according to this disclosure.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized. The analysis systems, methods and protocols illustrated herein can be readily implemented in hardware and/or software using any known or later developed systems or structures, devices and/or software by those of ordinary skill in the applicable art from the functional description provided herein and with a general basic knowledge of the communication arts.

Moreover, the disclosed methods may be readily implemented in software that can be stored on a non-transitory computer readable storage medium, executed on a programmed general-purpose computer with the cooperation of a controller and memory, a special purpose computer, a microprocessor, or the like. In these instances, the systems and methods of this disclosure can be implemented as program embedded on personal computer such as an applet, JAVA®, or a domain specific language, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present disclosure, systems, apparatuses and methods for funding a transaction between a consumer and a merchant. While this disclosure has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this disclosure.

What is claimed is:

1. A computer-implemented method for managing a payment processing system having a central processing system, the method comprising:
receiving, at the central processing system, a request from an authorized consumer access device; and
generating, in response to receiving the request, a Tender ID on-demand based on information contained in the request, wherein the information contained in the request comprises at least one of merchant name where payment will be made, type of service for which payment will be made, transaction type and transaction amount; and
returning the Tender ID to the authorized consumer access device, such that the Tender ID is useable with the requested merchant's POS in a format tailored to that merchant's POS.

2. The method of claim 1, further comprising:
generating, at the central processing system, a unique Transaction ID that is tied to the Tender ID in a database, wherein the Transaction ID references the consumer's requested transaction.

3. The method of claim 2, further comprising:
receiving, at the central processing system, a request from an authorized merchant POS, which contains the previously generated Tender ID; and
returning an authorization to the merchant's POS system that enables the merchant to tender the consumer transaction, and stores the specific transaction information within the central processing system database.

4. The method of claim 3, wherein the central processing system references the unique Transaction ID to query the database to obtain information to create payment files supporting payment processing transactions with third party entities, the payment files to leverage combined information from the consumer requested transaction, merchant POS transactions, and a profile of billers.

5. The method of claim 1, wherein the authorized consumer access device includes at least one of a mobile phone, a kiosk, a mobile computing device, and a Web enabled computer or laptop.

6. The method of claim 1, wherein the Tender ID is processed and rendered through the authorized consumer access device enabling them to be entered into a plurality of merchant POS systems.

7. The method of claim 1, wherein the Tender ID is reusable to process transactions, the transactions occurring at the same merchant, or involving the same receiving account, or bearing some other similarity that warrants or enables reuse of a consistent Tender ID.

8. The method of claim 1, further comprising:
enabling consumers, using a mobile device, PC or other connected device, to establish their account information for selected third parties to whom they wish to remit funds, the information including at least one of a name of the entity or individual, a customer account number, a due date, a payment category, a reoccurring payment amount, accounts to which funds are regularly applied, or other required information;
during the account creation process, enabling consumers to establish passwords and/or personal identification numbers (PINs) to enable security; and
during the account creation process, providing a computer implemented means to validate the consumer's billing account data, which may include an interaction between the central processing system and the biller or billing aggregator system.

9. The method of claim 1, further comprising automatically notifying customers via a mobile communications device when they are in the proximity of a merchant with whom they have previously made a payment.
